(19) United States
(12) Patent Application Publication
(10) Pub. No.: US 2005/0187885 A1
(43) Pub. Date: Aug. 25, 2005

(54) Methods and systems for sending a gift to a mailbox

(76) Inventors: Gregory J. Allen, Washington, DC (US); Lauren R. Sposato, Germantown, MD (US); Frank Papandrea, Vienna, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/917,328

(22) Filed: Aug. 13, 2004

Related U.S. Application Data
(60) Provisional application No. 60/494,810, filed on Aug. 14, 2003.

(51) Int. Cl. G06F 17/60

(52) U.S. Cl. 705/401

(57) ABSTRACT

A consumer may purchase a single item containing a gift, a shipping package, and pre-paid postage. The consumer may write a recipient's address on the shipping package and deposit the package in any delivery receptacle for delivery to the recipient. A delivery receptacle may be available at the point of purchase, enabling the consumer to purchase, package, and send a gift in a matter of a few minutes from a single location.

This application claims priority to U.S. Provisional Application Ser. No. 60/494,810, filed on Aug. 14, 2003, the contents of which are hereby incorporated by reference into this application as if set forth herein in full.

### TECHNICAL FIELD

The present invention relates to a method and a system for sending a gift to a mailbox. In particular, the method and system of the present invention allows a consumer to select a gift and send it to a recipient in a shipping package that includes prepaid postage from a single location.

### BACKGROUND

Today's consumers are busier than ever. They demand convenience while still expecting quality products and efficient service as they complete their daily tasks. One common task of consumers is gift giving. Throughout the year, many occasions, such as birthdays and holidays, prompt the exchange of gifts. Furthermore, gifts are often given for no reason at all. However, the process of giving a gift typically includes many time consuming steps: selecting a gift, purchasing a gift card, wrapping the gift, and delivering the gift to the recipient. If the recipient is located far from the giver, this process may include even more steps: packaging the gift for shipping, purchasing postage for the package, and taking the package to a shipper, such as the United States Postal Service.

All of these steps take time to accomplish. In addition, once the consumer has selected the gift, having it packaged and shipped typically requires the consumer to travel to a second location. This requires even more time on the part of the consumer. Therefore, with convenience and ease of use increasingly important criteria for busy consumers when purchasing gifts and shipping gifts, systems and methods are needed that provide consumers with an efficient manner to purchase and ship gifts from a single location.

### SUMMARY

Systems and methods consistent with the present invention make everyday tasks, such as gift giving, more convenient for consumers. In one embodiment, a consumer may purchase a single item containing a gift, a shipping package, and pre-paid postage. The consumer may simply write a recipient's address on the shipping package and deposit the package in any delivery receptacle for delivery to the recipient. Indeed, a delivery receptacle may be available at the point of purchase, enabling the consumer to purchase, package, and send a gift in a matter of a few minutes from a single location.

Consistent with the present invention, a method for providing a sales unit comprises marking the sales unit with a postage indicator; providing the sales unit to a purchaser; receiving the sales unit and an indicator of a recipient from the purchaser; and delivering the sales unit to the recipient.

Consistent with the present invention, a sales unit comprises a gift; a novelty item related to the gift; a container for the gift and the novelty item; and a postage indicator marked on the container, the postage indicator authorizing a shipping service to send the sales unit to a recipient.

Consistent with the present invention, a method for providing a sales unit comprises marking the sales unit with a postage indicator; providing the sales unit to a retailer; receiving the sales unit with an indicator of a recipient; and delivering the sales unit to the recipient.

Consistent with the present invention, a method for providing a sales unit with prepaid postage comprises providing the sales unit to a purchaser; receiving the sales unit and an indicator of a recipient from the purchaser; and delivering the sales unit to the recipient.

Consistent with the present invention, a sales unit comprises a gift; a container for the gift; and a postage indicator marked on the container, the postage indicator authorizing a shipping service to deliver the sales unit to a recipient.

Consistent with the present invention, a sales unit comprises a container for a gift; and a postage indicator marked on the container, the postage indicator authorizing a shipping service to deliver the sales unit to a recipient.

Consistent with the present invention, a system for processing an order for a sales unit with prepaid postage comprises a network connection; and a server coupled to the network connection, the server receiving data for an order comprising a sales unit with prepaid postage and a recipient of the sales unit.

### BRIEF DESCRIPTION OF THE DRAWINGS

Both the foregoing general description and the following detailed description are exemplary and explanatory only. They do not restrict the invention, as claimed. Furthermore, the accompanying drawings, which are incorporated in and constitute a part of this specification, illustrate one (or several) embodiments of the invention and together with the description, serve to explain the principles of the invention. In the drawings:

FIG. 1 is a block diagram of a sales unit consistent with the present invention;

FIG. 2 is a flow chart of a process consistent with the present invention;

FIG. 3 is a flow chart of another process consistent with the present invention;

FIGS. 4-8 depict exemplary markings for sales units consistent with the present invention; and

FIG. 9 is a diagram of an exemplary system consistent with the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

Description of Sales Unit

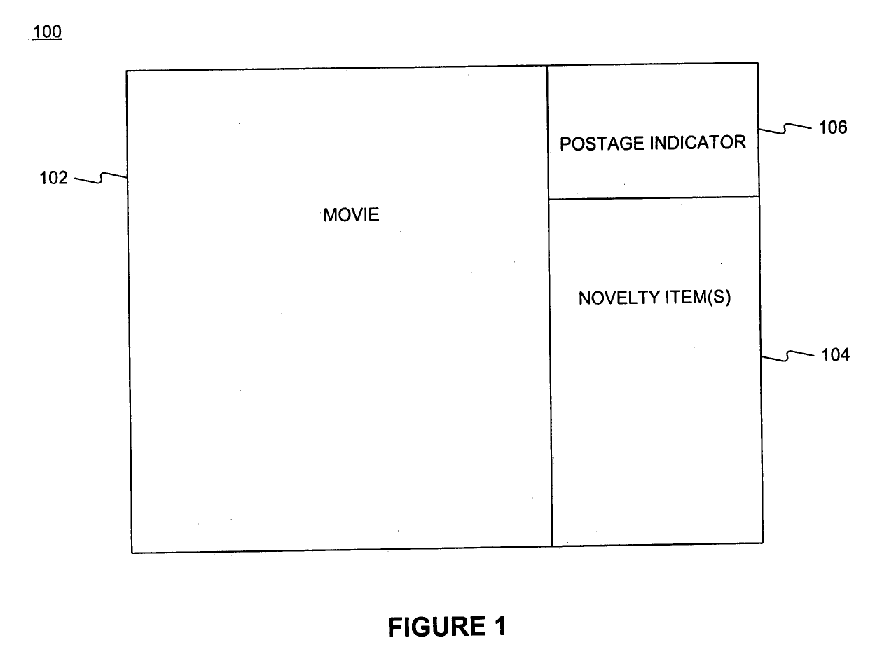

FIG. 1 is a block diagram of a sales unit consistent with the present invention. A sales unit 100 may be provided including a gift 102, a novelty item 104, and a postage indicator 106. Gift 102 may be, for example, a DVD or videotape of a movie. Novelty item 104 may be, for example, a plush toy or a snack item. The novelty item may be related to the gift. For example, if the gift is the movie “The Cat in the Hat,” the novelty item may be a stuffed Cat in the Hat animal. More than one novelty item may be included, for example, a toy and a package of popcorn. Postage indicator 106 may be, for example, a pre-paid postage indicia printed on sales unit 100.

Sales unit 100 may comprise a container, such as a Priority Mail box from the United States Postal Service. The container may include markings related to the contents, e.g., a logo associated with the movie, the name of the movie, the names of actors in the movie, etc. Additionally or alternatively, the container may be marked with holiday-related phrases or decorations, such as “Happy Birthday” or “Merry Christmas,” or the name of the entity providing the sales unit.

Sales unit 100 may also be customized to a particular shape or size depending upon the desired use. For example, sales unit 100 may be a prepaid postage package matching the size of a DVD case, a VHS videotape, or a CD, for example. Sales unit 100 may also be customized to a size that would allow it to fit into a standard rural mailbox.

Processes for Providing Sales Unit

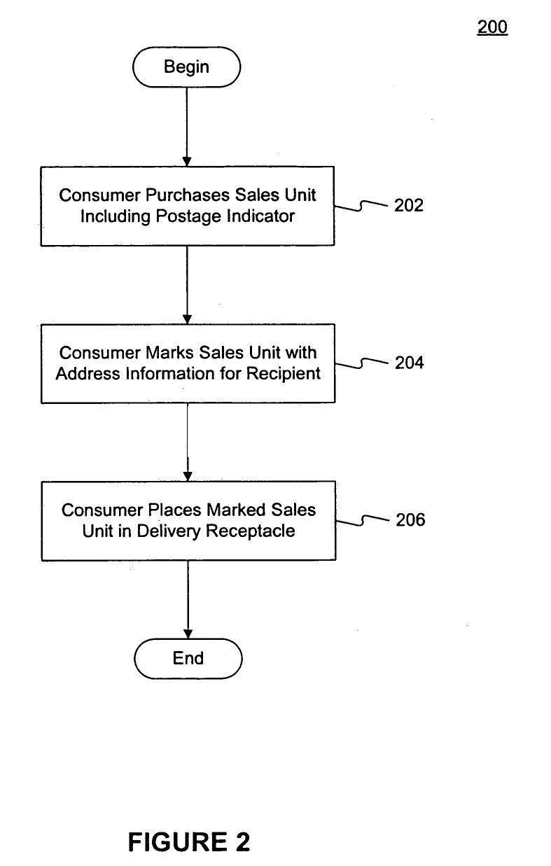

FIG. 2 is a flow chart of a process consistent with the present invention. When a consumer purchases a sales unit including a postage indicator (step 202), the consumer may mark the sales unit with address information of a recipient (step 204). The consumer then places the marked sales unit in a delivery receptacle (step 206) for delivery to the recipient. The delivery receptacle may comprise, for example, a mailbox for receiving mail. A gift card may also be included with the sales unit for the convenience of the consumer. In this way, a consumer could select a movie, novelty item, gift card, etc., insert them into a container, add the address of the recipient, and deposit the package into a special collection box at the point of purchase or any mailbox.

In an alternative embodiment, the consumer may select which movie to include in the sales unit. For example, the consumer may select among several different movies, novelty items, and/or labels. Once the consumer chooses a movie and/or a novelty item, the consumer may use the labels to adorn the box containing the selected movie and/or novelty item. This embodiment may be offered, for example, in a retail outlet that sells many different movies. A collection box may be provided in the retail outlet for the convenience of the consumer. Once the sales unit is assembled and purchased, the purchaser may add the recipient's address and deposit the sales unit in the collection box.

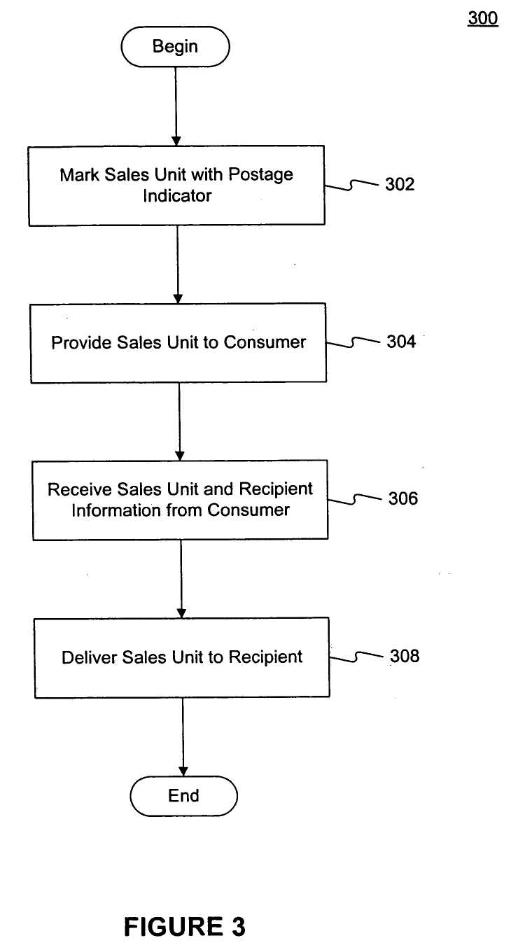

FIG. 3 is a flow chart of another process consistent with the present invention. Before it is offered to the consumer, a sales unit may be marked with a postage indicator (step 302) and the cost of postage for the sales unit may be included in the purchase price. For example, if the sales unit weighs 2 pounds and the cost of delivering a two-pound package is $3.80, then the cost of the sales unit would include $3.80 for postage. The cost of the sales unit may also include the cost of the movie, any novelty items included, the packaging, postage, and a profit amount.

The sales unit is then provided to a consumer (step 304). Sales units consistent with the present invention may be distributed in any number of ways. Sales units may be sold, for example, in retail stores, such as drug stores or warehouse outlet stores, movie rental stores, movie theaters, Post Offices, etc. Sales units may also be sold over a network, such as the Internet, or through mail or phone order.

After a sales unit is received from a consumer together with recipient information, e.g., a recipient address, (step 306), the sales unit is delivered to the recipient (step 308). The process depicted in FIG. 3 may be performed by any appropriate entity or combination of entities, including a shipping service, such as the United States Postal Service, a movie studio, such as Universal Pictures, and/or a movie rental chain, such as Blockbuster Video. A program for selling and marketing sales units may be called, for example, Movie in the Mailbox.™ However, it should be noted that while the following example describes the invention in relation to a movie, any gift item, such as a t-shirt, book, nonperishable food items, or any other gift item that may be legally sent in the mail is contemplated and consistent with the spirit and scope of the present invention.

In addition, other products may be used to promote and/or enhance the sales units. For example, pre-paid phone cards may be included in the sales unit or may be marked with advertising for the sales unit and sold separately. In another example, posters for a movie may be used in sales locations to advertise sales units containing movies. The sales unit may include an item for the consumer to keep, in addition to the items that will be sent to the recipient. For example, a movie poster may be sold together with a movie sales unit. The consumer may keep the movie poster and send the movie sales unit to the recipient. In another example, a movie ticket or voucher for a movie ticket may be included with the movie sales unit.

Sales clerks or other personnel may also be used to promote and/or enhance the sales unit. For example, clerks at sales locations may wear articles of clothing, pins, etc. related to the movie sales units. If the movie being sold is “The Cat in the Hat,” sales clerks may wear, for example, hats similar to the one worn by the cat in the movie or a clerk may dress up in a costume like a character in the movie. In one embodiment, these types of promotions may be centered around special times of year, e.g., the Christmas season, or special times of the week, e.g., on weekends. Charitable or promotional events, such as movie screenings or readings of books related to the movie, may also be used to promote and/or enhance the movie sales unit.

Discounts or rewards may also be used to promote and/or enhance the sales unit. For example, a sweepstakes entry may be included with the sales unit with a prize related to the sales unit, such as a trip to Universal Studios theme park combined with movie sales units. In another example, consumers may obtain a discount on the price of the sales unit by using a promotional credit card or by purchasing the sales unit at a specified location. In yet another example, an order form for a sales unit could be included in a mailpiece sent to a prospective consumer, such as a flyer inserted into the consumer's credit card bill.

Exemplary Sales Units

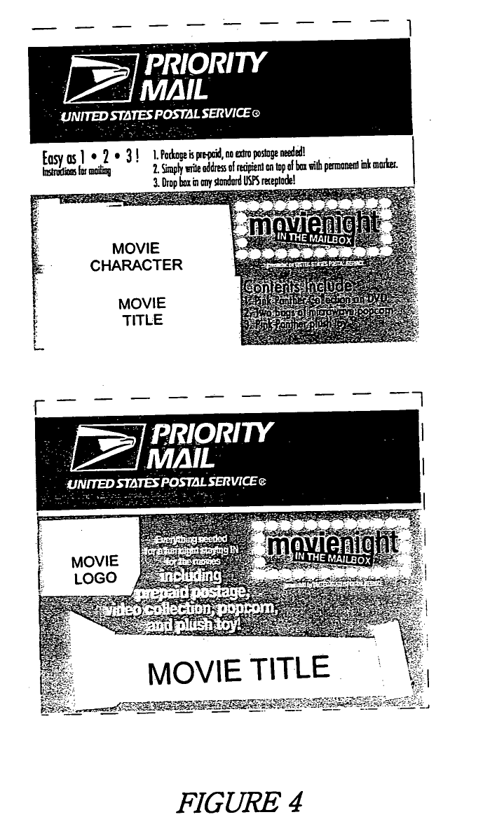

FIGS. 4-8 depict exemplary markings for sales units consistent with the present invention. For example, FIG. 4 depicts an exemplary movie sales unit. The label includes an image of a movie character, a logo of the movie, instructions for the consumer, and a logo of the United States Postal Service. Postage indicia (not shown) may also be included. The label of FIG. 4 may be applied to a container, such as a box, to create a sales unit consistent with the present invention.

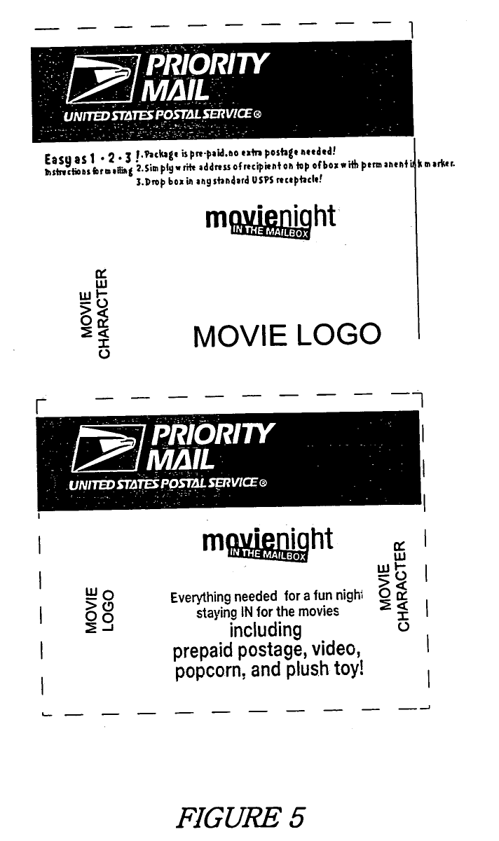

FIG. 5 depicts a label for an exemplary movie sales unit. The label includes the title of the movie, a logo of the movie, instructions for the consumer, and a logo of the United States Postal Service. Postage indicia (not shown) may also be included. The label of FIG. 5 may be applied to a container, such as a box, to create a sales unit consistent with the present invention.

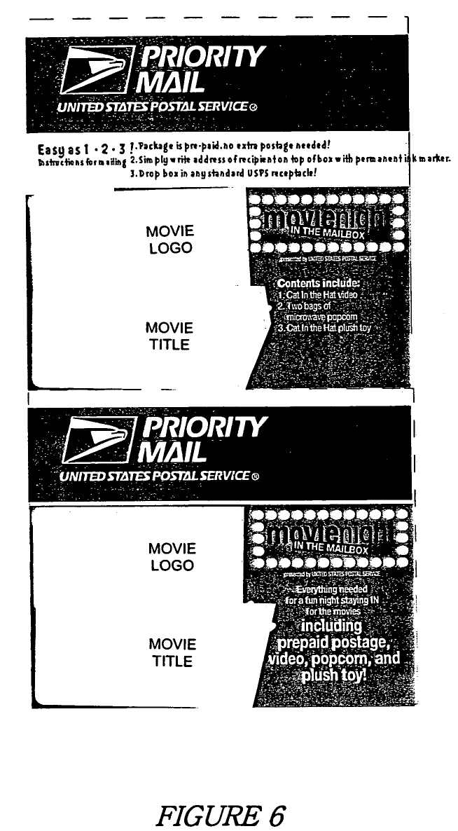

FIG. 6 depicts an alternative label for an exemplary movie sales unit. The label includes a logo of the movie, instructions for the consumer, and a logo of the United States Postal Service. Postage indicia (not shown) may also be included. The label of FIG. 6 may be applied to a container, such as a box, to create a sales unit consistent with the present invention.

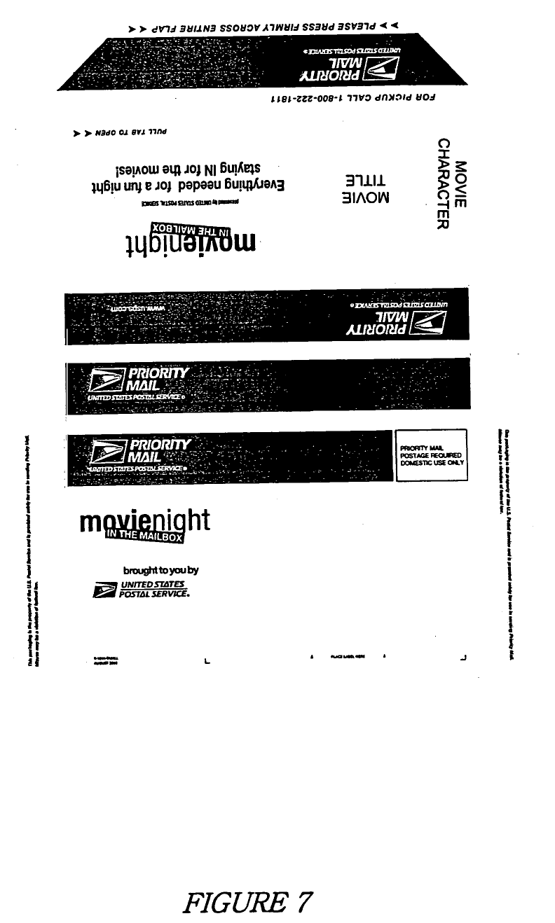

FIG. 7 depicts a box design for another exemplary movie sales unit. The box design includes the movie title, a logo of the movie, a logo of the United States Postal Service, and a phone number the consumer may call to arrange pick up of the package. Postage indicia (not shown) may also be included.

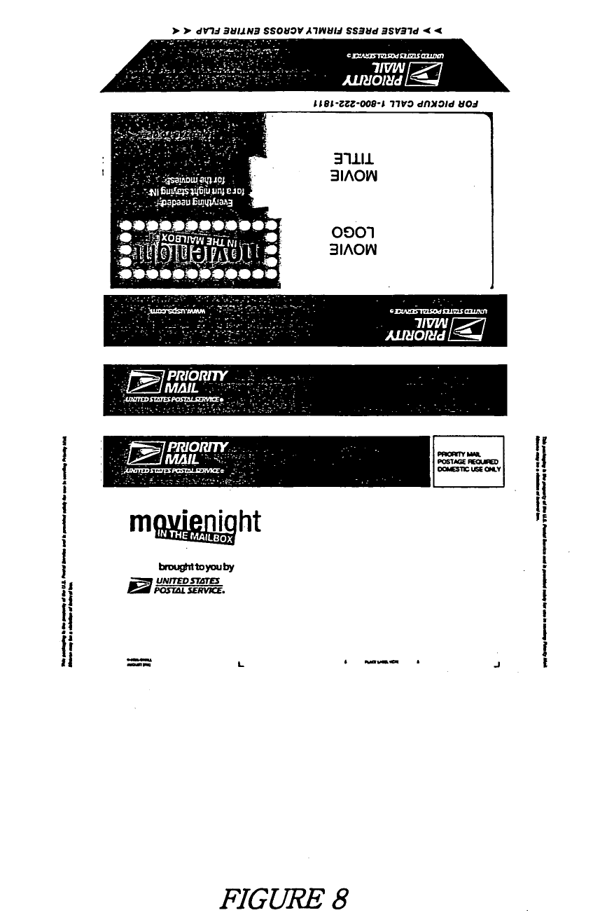

FIG. 8 depicts an alternative box design for a movie sales unit. The box design includes a logo of the movie, a logo of the United States Postal Service, and a phone number the consumer may call to arrange pick up of the package. Postage indicia (not shown) may also be included.

In other embodiments consistent with the present invention, a sales unit including prepaid postage may be sold to a retailer. The selling price may include a markup fee to the price of the sales unit when it is sold to consumers. In addition, sales units with prepaid postage that are shipped to retailers may be prepackaged to include one or more gift items. In such an embodiment, a retailer may optionally add a markup fee to the cost of the sales units and sell the sales to consumers. Alternatively, sales units with prepaid postage comprising empty packages may be shipped to retailers. In such an embodiment, the retailer or the consumer may select any items for inclusion in the sales unit that will physically fit into the package or that do not exceed a predetermined weight. Different size sales units may be provided to allow for variation in the quantity of items a consumer can ship.

Exemplary Internet Sales Order System

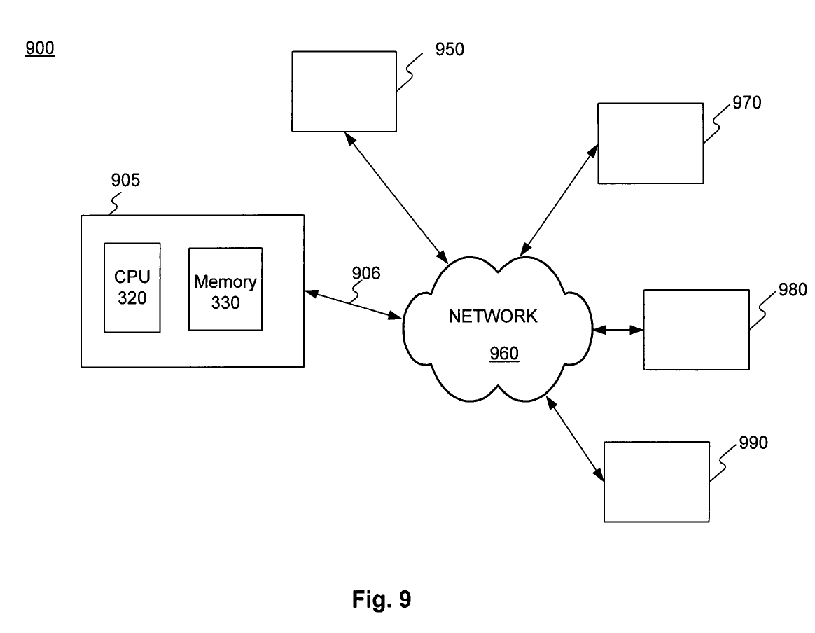

FIG. 9 is a diagram of an exemplary system 900, consistent with the invention, to implement the steps described above. System 900 includes a server 905 with a CPU 920 and a memory 930, and a connection 906 to a network 960. Software in memory 930 preferably implements computer instructions for providing a gift to a mailbox. The software may, for example, implement a webpage. Network 960 provides communications between the various components in system 900, such as user terminals 970-990. Network 960 may be a shared, public, or private network and encompass a wide or local area.

Terminals 970-990 allow a user to send and/or receive information to/from server 905. Terminals 970-990 may be any type of appropriate device for communicating with server 905 over network 960. For example, terminal 970 may be a PDA running a program for communicating with server 905, while terminal 980 may be a desktop computer running a web browser for communicating with sever 905 via the Internet. Optionally, terminal 990 may be a standard landline telephone or wireless phone.

For example, a customer may access server 905 via network 960 or operate a web browser or software running on terminal 980. Data may be sent over network 960 to and from server 905 to terminal 980 during the customer's shopping experience. A customer may navigate to a webpage where the customer may select from a list of gift items. The customer may then provide the name and address of the recipient and may submit that information over network 960. Once the customer has selected one or more gift items and provided the name an address of the recipient, the customer may provide identification and payment information, such as the customer's name, address, telephone number, e-mail address, and credit card or debit account information. The submitted information is sent over to network 960, processed, and the sales transaction is approved. A confirmation screen may be displayed to indicate the completion of the transaction and/or the customer may be sent an e-mail message as confirmation if the customer supplied an e-mail address.

Server 905 may then determine the appropriate size sales unit for the gift items, and may provide a finalized order, which may then be fulfilled so that the selected items are sent to the recipient.

In other various embodiments, a customer operating a telephone at terminal 990 may contact a customer service representative at terminal 950. The customer service representative may take the order from the customer and may make selections using software running on terminal 950 to produce the order.

One skilled in the art will recognize that many alternative embodiments of the present invention are possible. For example, a sales unit consistent with the present invention may include more than one movie and the postage indicator on the sales unit may reflect the postage for shipping more than one movie. The postage indicator and sales unit may also vary based on whether the movie is in DVD or videotape format. In another example, other types of gifts and sales units may be used. The gift may be a greeting card and the sales unit may be an envelope with a pre-paid postage indicia. Other alternatives are possible without departing from the spirit and scope of the invention.

The foregoing descriptions of the invention have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

Other embodiments of the invention will be apparent to those skilled in the art from consideration of the specification and practice of the invention disclosed herein. The specification and examples should be considered as exemplary only, with a true scope and spirit of the invention being indicated by the following claims.

1. A method for providing a sales unit, comprising:
marking the sales unit with a postage indicator;
providing the sales unit to a purchaser;
receiving the sales unit and an indicator of a recipient from the purchaser; and
delivering the sales unit to the recipient.

2. The method of claim 1, wherein the sales unit further comprises a gift and a novelty item.

3. The method of claim 1, comprising receiving a selling price amount from the purchaser.

4. The method of claim 2, wherein the gift is a movie and the novelty item relates to the movie.

5. A sales unit, comprising:
a gift;
a novelty item related to the gift;
a container for the gift and the novelty item; and
a postage indicator marked on the container, the postage indicator authorizing a shipping service to send the sales unit to a recipient.

6. The sales unit of claim 5, wherein the gift is a movie.

7. A method for providing a sales unit, comprising:
marking the sales unit with a postage indicator;
providing the sales unit to a retailer;
receiving the sales unit with an indicator of a recipient; and
delivering the sales unit to the recipient.

8. The method of claim 7, wherein the receiving occurs at a retailer location.

9. A method for providing a sales unit with prepaid postage, comprising:
providing the sales unit to a purchaser;
receiving the sales unit and an indicator of a recipient from the purchaser; and
delivering the sales unit to the recipient.

10. The method of claim 9, wherein the receiving occurs at a retailer location.

11. A sales unit, comprising:
a gift;
a container for the gift; and
a postage indicator marked on the container, the postage indicator authorizing a shipping service to deliver the sales unit to a recipient.

12. A sales unit, comprising:
a container for a gift; and
a postage indicator marked on the container, the postage indicator authorizing a shipping service to deliver the sales unit to a recipient.

13. A system for processing an order for a sales unit with prepaid postage, comprising:
a network connection; and
a server coupled to the network connection, the server receiving data for an order comprising a sales unit with prepaid postage and a recipient of the sales unit.

14. The system of claim 12, further comprising:
a terminal, the terminal displaying a user interface for placing the order.

15. The system of claim 12, wherein the order is for a gift.
